(19) United States
(12) Patent Application Publication
(10) Pub. No.: US 2026/0200466 A1
(43) Pub. Date: Jul. 16, 2026

(54) Method for Evaluating the Safety of a Lane-Change Maneuver in the Automated Driving Mode of a Vehicle

(71) Applicant: Mercedes-Benz Group AG, Stuttgart (DE)

(72) Inventors: Laurin VASILE, Stuttgart (DE); Maximilian SEEMANN, Duelmen (DE)

(21) Appl. No.: 19/135,293

(22) PCT Filed: Nov. 29, 2023
(86) PCT No.: PCT/EP2023/083547

§ 371 Date: Jun. 3, 2025

(30) Foreign Application Priority Data
Dec. 5, 2022 (DE) 10 2022 004 543.5

(51) Int. Cl. B60W 30/095; B60W 30/18; G08G 1/16

(52) U.S. Cl. CPC B60W 30/0956; B60W 30/18163; G08G 1/167; B60W 2520/10; B60W 2520/105; B60W 2552/10; B60W 2554/4042; B60W 2554/4045; B60W 2554/802

(57) ABSTRACT

A method for the safety assessment of a lane change maneuver in the automated driving operation of a vehicle with a surroundings sensor system. The surroundings of the vehicle and objects located therein are detected by means of detected signals of the surroundings sensor system. The method provides that it can be checked even before the vehicle begins to change lanes as to whether a lane change itself can still be performed safely, even when the vehicle misjudges the lane-change maneuver in relation to other vehicles, or when a lane change cannot be predicted from a given context. For this reason, the collision probability is determined solely by the longitudinal dynamics since it is not possible to predict whether other vehicles will change lanes. Longitudinal dynamics means both longitudinal acceleration and jerk.

### BACKGROUND AND SUMMARY OF THE INVENTION

The invention relates to a method for the safety assessment of a lane change maneuver in the automated driving operation of a vehicle with a surroundings sensor system, wherein the surroundings of the vehicle and objects located therein are detected by means of detected signals of the surroundings sensor system.

A method for assessing a risk associated with a driving operation of an autonomous vehicle control system is known from U.S. Pat. No. 8,244,408 B2. A vehicle is configured to perform an autonomous lane change maneuver and is equipped with a monitoring system. Here, each of several objects that are located in the vicinity of the vehicle is monitored. Locations of each of the objects are predicted relative to a projected trajectory of the vehicle, and a collision risk level between the vehicle and each of the objects is assessed.

Moreover, EP 3 281 831 A1 describes a control system and a control method for determining a probability of a lane change by a preceding motor vehicle. The control system is formed to detect another motor vehicle participating in traffic in front of the actual motor vehicle by means of the at least one surroundings sensor, to determine a lateral movement of the other motor vehicle relative to a lane in which the other motor vehicle or the actual motor vehicle is located, and to calculate a movement-based probability of a lane change by the other motor vehicle by means of the determined lateral movement of the other motor vehicle. Furthermore, the control system is set up and intended to determine a current traffic situation in accordance with the surroundings data obtained by means of the surroundings sensor, to calculate a traffic situation-based probability of a lane change by the other motor vehicle by means of the determined current traffic situation, and to calculate an overall probability of a lane change by the other motor vehicle by means of the movement-based probability and the traffic situation-based probability.

Furthermore, a method for assessing a collision risk associated with an operation of a vehicle is known from US 2010/0 228 419 A1, wherein the vehicle is formed to perform an autonomous lane change maneuver. The method comprises the following steps:
monitoring each of a plurality of object vehicles that are located in the vicinity of the vehicle;
predicting the locations of each of the object vehicles relative to a projected trajectory of the vehicle in future time steps; and
assessing a collision risk level between the vehicle and each of the object vehicles in the future time steps.

DE 10 2019 129 879 A1 describes a method for the automated control of a motor vehicle that is travelling on a road in a current lane, wherein the road has an additional lane. The method comprises the following steps:
generating and receiving two preliminary driving maneuvers which comprise a change from the current lane to the additional lane and a starting point in time of the change, wherein the starting points in time of the two preliminary driving maneuvers are at different points in time;
comparing the two driving maneuvers, taking into consideration the respective starting point in time; and
selecting one of the starting points in time based on the comparison.

Furthermore, DE 196 47 430 A1 describes a method for automatically braking a passenger-driven motor vehicle, in which a relative speed to an obstacle located approximately in front of the vehicle in the direction of travel is determined. In addition, a distance between the vehicle and the obstacle is determined, wherein the determined distance is compared with a braking distance of the vehicle at a speed which approximately corresponding to the relative speed. Depending on the comparison result, an automatic braking process is carried out when the determined distance is shorter than the braking distance.

The object of the invention is to specify a novel method for the safety assessment of a lane change maneuver in the automated driving operation of a vehicle.

A method for the safety assessment of a lane change maneuver in autonomous driving operation of a vehicle with a surroundings sensor system, wherein the surroundings of the vehicle and objects located therein are detected by means of signals recorded by the surroundings sensor system, provides that:
before an initiated lane change maneuver of the vehicle from a left lane to a middle lane or from a right lane to a middle lane of a multi-lane road, a collision risk is determined by means of hypothetical lane change maneuvers of other vehicles in the right lane or the left lane, wherein:
based on a maximum lane change duration and a cutting-in moment, longitudinal accelerations are calculated that lead to a collision due to an overlap of the vehicle surfaces of the vehicle and the other vehicles,
the execution of the lane change maneuver is assessed depending on a relative longitudinal position of the vehicle to the other vehicles and the relative longitudinal speeds of the vehicle to the other vehicles at the start of a lane change maneuver by means of a collision probability as a safety measure and a minimum distance in the event of no collision as a further safety measure, and
when determining the collision probability, the magnitude of a jerk of longitudinal acceleration of the other vehicles is taken into consideration, wherein
the longitudinal acceleration of the vehicle is optimized in such a way that a minimum longitudinal acceleration and a maximum longitudinal acceleration of the other vehicles require a longitudinal acceleration change effort, which in each case has a statistically low collision probability.

According to the invention, the collision probability is determined as a safety measure by means of:
a previously determined probability of expected longitudinal accelerations of the other vehicles,
a starting situation,
geometric vehicle information of the vehicle and geometric vehicle information of the other vehicles,
from starting times of the hypothetical lane change maneuvers of the other vehicles,
a time duration of the lane change maneuver, and
a planned longitudinal acceleration of the vehicle.

In particular, the method provides that it can be checked even before the vehicle begins to change lanes as to whether a lane change itself can still be performed safely, even when the vehicle misjudges the lane-change maneuver in relation to other vehicles, or when a lane change cannot be predicted from a given context. For this reason, the collision probability is determined solely by means of the longitudinal dynamics, since it is not possible to predict whether other vehicles will change lanes. Here, longitudinal dynamics is to be understood to mean both longitudinal acceleration and jerk.

By applying the method, longitudinal acceleration optimizations of the automated vehicle are designed on the basis of an actual, in particular measured, initial longitudinal acceleration of a potential additional vehicle merging into the lane of the automated vehicle in such a way that the longitudinal acceleration of the potential merging vehicles requires a longitudinal acceleration change effort that has a statistically low probability of occurring, such that the collision probability is reduced.

Here, jerk is to be understood to mean the instantaneous rate of change of an acceleration of a body over time. In particular in a vehicle with an electric drive, a change in acceleration results in a longitudinal jerk.

In particular, the application of the method can be used to assess/quantify a collision risk of a vehicle at the tactical level for carrying out a lane change maneuver into the middle lane.

A system of the vehicle for automated, in particular autonomous, driving operation can reduce the collision risk even before the lane change maneuver by adapting its target behavior or temporally postpone the start of the lane change maneuver when both a positive and a negative acceleration effort are too high for the vehicle and/or until the initial situation for a safe lane change has improved.

Exemplary embodiments of the invention are explained in more detail below by means of the drawings.

### BRIEF DESCRIPTION OF THE DRAWINGS

FIG. 1, schematically, shows a lane portion with three lanes and two vehicles;

FIG. 2, schematically, shows two depictions of the lane portion with one and the same starting situation and changed longitudinal acceleration;

FIG. 3, schematically, shows a derivation of the jerk moment in a certain situation;

FIG. 4, schematically, shows a derivation of the jerk moment in a further certain situation;

FIG. 5, schematically, shows a derivation of the jerk moment in a further certain situation;

FIG. 6, schematically, shows a derivation of the jerk moment in a further certain situation;

FIG. 7, schematically, shows a depiction of starting position limiting cases and their relative longitudinal speed courses;

FIG. 8, schematically, shows a derivation of a collision probability as a safety measure;

FIG. 9, schematically, shows a depiction of a calculation of a minimum distance between the vehicle and a nearest further vehicle on a next but one lane as a further safety measure;

FIG. 10, schematically, is a depiction of different limiting cases for calculating longitudinal acceleration limits;

FIG. 11A, schematically, is a diagram with a collision probability density without taking a jerk into consideration;

FIG. 11B, schematically, is a further diagram with shifted collision probability density by adjusting a longitudinal acceleration of the vehicle;

FIG. 12A, schematically, is a diagram with a collision probability density and longitudinal acceleration limits;

FIG. 12B, schematically, is a calculation, depicted in a diagram, of the longitudinal acceleration differences, which are used to calculate jerk limits; and

FIG. 12C, schematically, is a diagram considering an occurrence probability of a jerk of a longitudinal acceleration.

### DETAILED DESCRIPTION OF THE DRAWINGS

Parts corresponding to one another are provided with the same reference number in all figures.

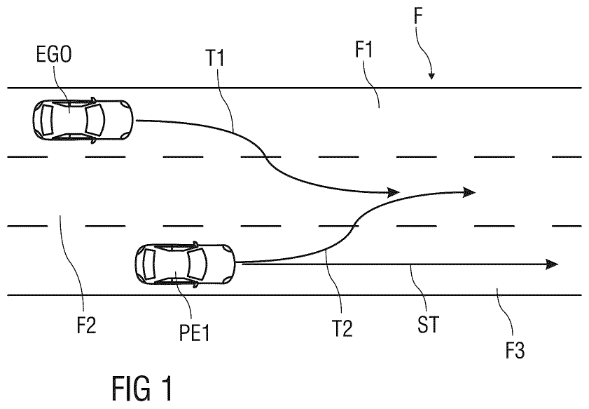

FIG. 1 shows a lane section F with three lanes F1 to F3 running in the same direction. A vehicle EGO is travelling in autonomous mode in a left lane F1 and intends to perform a lane change maneuver into a center lane F2. Here, a lane change trajectory T1 of the vehicle EGO from the left lane F1 to the center lane F2 is depicted.

A further vehicle PE1 is travelling in a right lane F3, which may possibly, i.e., even without any discernible intention, intend to perform a lane change maneuver into the center lane F2. A hypothetical lane change trajectory T2 of the further vehicle PE1 from the right lane F3 to the center lane F2 is also depicted. A lane following trajectory ST of the further vehicle PE1, which exclusively relates to the right lane F3, is also shown in FIG. 1.

For automated, in particular autonomous, driving operation of a vehicle EGO, a lane change represents a comparatively complex driving maneuver. To do so, it is necessary to plan and implement longitudinal and transverse movements of the vehicle EGO, taking into consideration the surroundings situation.

According to Donges and Michon, it is known that an evaluation of a lane change maneuver takes place on three levels, namely a strategic, tactical, and operational level. The following problem description refers in particular to the tactical level, which describes the attractiveness and feasibility of a lane change maneuver. Typically, an autonomous lane change at this level is only analysed by including object information, which is allocated to the vehicle's own lane, according to the present exemplary embodiment in FIG. 1, the left lane F1, and a target lane ZS, i.e., the center lane F2. However, object information of further vehicles PE1 to PE3, which are shown in the following figures, in the next but one lane, i.e., the right lane F3, is not taken into consideration or is taken into consideration only indirectly, for example, via potential fields, when a predicted behavior is irrelevant for the target lane ZS. A number of the further vehicles PE1 to PE3 is not fixed at 3 and can vary. Incorrect predictions or lane changes that are not apparent from a context are therefore not taken into consideration or are only taken into consideration through generic fallback trajectories. However, during lane-changing maneuvers on three- or multi-lane road sections F, in particular on a motorway, from a left lane F1 or a right lane F3 to the center lane F2, it may happen that a further vehicle PE1 to PE3 decides to change to the same target lane ZS during the same period of time, even without any discernible intention. Such a case represents a comparatively critical situation.

In lane change maneuvers, there is a risk of collision with further vehicles PE1 to PE3 that could change to the middle lane F2 during the same period.

While a human driver of the vehicle EGO can assess the behavior of surrounding traffic during lane change maneuvers based on their previous experience, also taking into consideration objects, i.e., traffic participants, in the next but one lane, in relation to FIG. 1 in the right lane F3, in order to then evaluate their tactical driving decision in terms of attractiveness and feasibility, automated vehicle systems are dependent on rule sets that evaluate planned tactical behavior based on measurement data of a surroundings sensor system.

In particular, here there is neither a risk quantification, in particular in the form of a safety measure S1, S2, nor a calculation rule for a desired target behavior of the automated driving system of the vehicle EGO.

In order to evaluate on a tactical level a lane change maneuver into the center lane F2 while considering object information in the next but one lane, i.e., the right lane F3, it is thus necessary to define metrics and parameters that allow for a quantification of the collision risk of these objects during lane change maneuvers. Based on this, a desired target behavior for the automated driving system can then be derived.

A method for the safety assessment of a lane change maneuver in the autonomous driving mode of the vehicle EGO with a surroundings sensor system is described below, wherein the surroundings of the vehicle EGO and objects located therein are detected by means of recorded signals of the surroundings sensor system.

To carry out the method, it is assumed that lane change maneuvers of further vehicles PE1 to PE3 cannot be predicted.

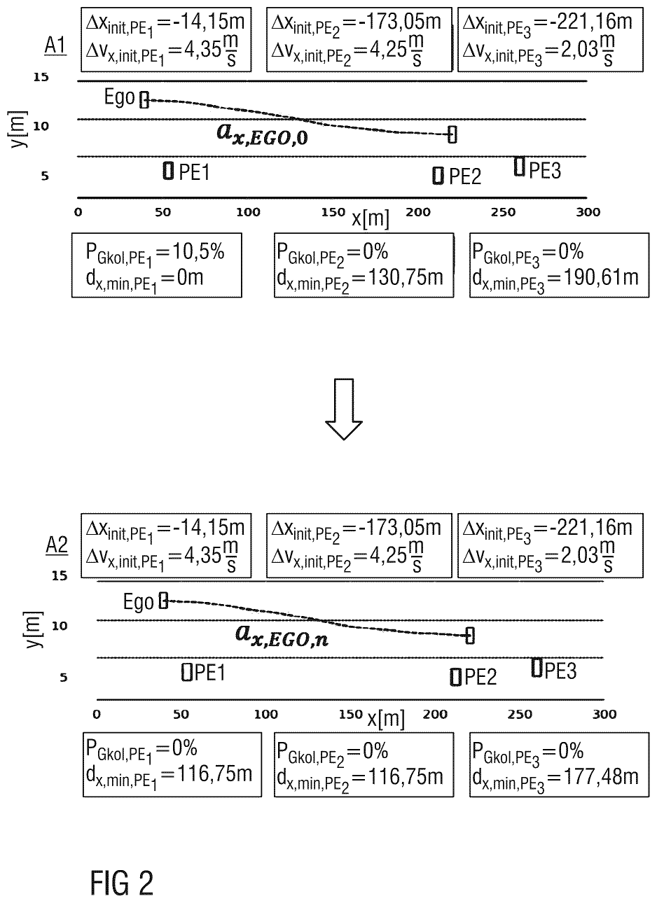

In FIG. 2, two images A1, A2 are shown with a lane section F and the same starting situation Δx_{MM,init,PE}_{ᵢ}, Δv_{x,init,PE}_{ᵢ}, wherein the vehicle EGO is travelling in the left lane F1 and intends to perform a lane change maneuver into the center lane F2. Three further vehicles PE1 to PE3 are travelling in the right lane F3.

A lane change maneuver of vehicle EGO into the center lane F2 is tested in relation to a collision by means of hypothetical lane change maneuvers of the further vehicles PE1 to PE3, wherein these further vehicles can be passenger cars or even trucks. This means that each of the further vehicles PE1 to PE3 represents a potential lane changer for vehicle EGO. The further vehicles PE1 to PE3 can also be other modes of transport, such as motorcycles, for example, wherein here, acceleration ranges are also determined, and the same principle is applied to the risk analysis in relation a lane change of vehicle EGO.

To verify the lane change maneuver by means of the hypothetical lane change maneuvers of the further vehicles PE1 to PE3, longitudinal accelerations a_{x,PE} are calculated using linearized transverse profiles, in particular based on a maximum lane change duration and a cut-in moment, the longitudinal accelerations leading to a collision due to an overlap of vehicle surfaces between the vehicle EGO and one of the further vehicles PE1 to PE3. For this purpose, it is defined that the probability of occurrence of the respective longitudinal accelerations a_{x,PE} which lead to a collision simultaneously describes a collision probability P_{Collision} or corresponds to the collision probability P_{Collision}, since the longitudinal acceleration a_{x,PE} is directly related to an overlap of vehicle surfaces and thus to a collision.

An evaluation of the lane change maneuver on a tactical level is carried out depending on a relative longitudinal position Δx_{MM,init,PE}_{ᵢ}, also referred to as the initial distance between vehicle centers, as vehicle measurement variable 1 and an initial relative longitudinal speed Δv_{x,init, PE}_{ᵢ} as vehicle measurement variable 2 at the beginning of the lane change maneuver by means of two safety measures S1, S2.

Here, the relative longitudinal position Δx_{MM,init,PE}_{ᵢ} emerges as follows:

$$Δ {x}_{MM , init , {PE}_{i}} = {x}_{M , EGO , init} - {x}_{M , {PE}_{i} , init} \qquad ( 1 )$$

The initial relative longitudinal speed Δv_{x,init,PE}_{ᵢ} is calculated as follows:

$$Δ {v}_{x , init , {PE}_{i}} = {v}_{x , EGO , init} - {v}_{x , {PE}_{i} , init} \qquad ( 2 )$$

In particular, an initial longitudinal distance is negative when the vehicle EGO is travelling behind another vehicle PE1 to PE3. Similarly, a relative speed Δv_{x (t}_{_{SP}}₎ is positive when the vehicle EGO has a higher longitudinal speed v_{x,EGO,init} than a further vehicle PE1 to PE3.

A safety measure S1 represents the collision probability P_{Collision} and a further safety measure S2 represents, if no collision is imminent, a minimum distance d_{x,min} between the vehicle EGO and the other vehicles PE1 to PE3.

An assessment of the collision probability P_{Collision} as a safety measure S1 is carried out by means of a collision probability P_{Collision}, which results from a previously determined probability of expected longitudinal accelerations a_{x,PE} of the further vehicles PE1 to PE3, by means of the starting situation Δx_{MM,init,PE}_{ᵢ}, Δv_{x,init,PE}_{ᵢ}_{,}, by means of a piece of geometric vehicle information l_{EGO} of the vehicle EGO, a piece of geometric vehicle information l_{PE} of the further vehicles PE1 to PE3, by means of the lane change start times of the further vehicles PE1 to PE3, a duration of the lane change maneuver and a planned longitudinal acceleration a_{x,EGO,n} of the vehicle EGO.

An evaluation of the minimum distance d_{x,min} as a further safety measure S2 is carried out by means of a minimum longitudinal distance between the bumpers closest to each other. Here, the minimum distance d_{x,min} is chosen throughout the entire lane change maneuver after the transverse coordinates between the vehicle EGO and at least one further vehicle PE1 to PE3 intersect.

A calculation of the two safety measures S1, S2 is carried out based on a model.

By changing the longitudinal acceleration a_{x,EGO,n}, depicted by means of the index n, and/or a lane change duration, the vehicle EGO can influence the collision probability P_{Collision} and the minimum distance d_{x,min} during the lane change maneuver.

In a first depiction A1, a scenario with three further vehicles PE1 to PE3 as potential mergers into the center lane F2 is shown in their respective starting situation Δx_{MM,init,PE}_{ᵢ}, Δv_{x,init,PE}_{ᵢ}.

A total collision probability P_{GKol,PE}_{ᵢ}_{,n>}0 of the vehicle EGO exists for the vehicle EGO with a further first vehicle PE1, wherein in the first depiction A1 a minimum distance d_{x,min} to the respective further vehicle PE1 to PE3 applies with a longitudinal acceleration a,_{x,EGO,0}, which is set to zero with a total collision probability P_{GKol,PE}_{ᵢ}_{,n}>0.

In a second depiction A2 in FIG. 2, the same starting situation Δx_{MM,init, PE}_{ᵢ}, Δv_{x,init,PE}_{ᵢ} is depicted as in the first depiction A1. Here, the vehicle EGO has a changed longitudinal acceleration a_{x,EGO,n}, such that new values for the respective collision probability P_{Collision} and the respective minimum distance d_{x,min} are the result of this.

The vehicle EGO is thus able to reduce a collision risk before the initiated lane change maneuver or to deliberately postpone the start of the lane change maneuver if the positive or negative acceleration effort of the vehicle EGO is too high and/or until the initial situation for a safe lane change has improved.

To carry out the method, a definition of a start time and an end time of the lane change maneuver is required in order to distinguish a respectively present scenario from further scenarios. These times are determined according to the method known from source: Vasile, Laurin, Kiran Divakar, and Dieter Schramm. Deep-Learning Basierte Verhaltensprädiktion Rückwärtiger Verkehrsteilnehmer Für Hochautomatisierte Spurwechsel. (ENG: Deep Learning Based Behavior Prediction of Reversing Traffic Participants for Highly Automated Lane Changes.) Transforming Mobility-What Next? Conference Proceedings of the 13th Science Forum on Mobility: Springer Fachmedien Wiesbaden, 2021.

By means of a defined start and end time of a lane-changing maneuver, averaged longitudinal accelerations are determined based on the recorded measurement data depending on a lane-changing direction, in particular with regard to a faster/slower lane F1 to F3, and a vehicle class, from a real-world driving dataset with which lane-changing maneuvers are performed. Moreover, the probability of an averaged longitudinal acceleration with which the lane-changing maneuver is performed is also determined. Here, a probability density function pdf is respectively created via a frequency distribution depending on the lane-changing direction and vehicle class, the integral of which describes the probability of a corresponding acceleration range. The probability density function pdf is then applied to the further vehicles PE1 to PE3 depending on the lane-changing direction and their vehicle class.

Based on the measured data, a lane change duration t_{PE} (Δy_{ZM}) is furthermore determined by means of the start and end times depending on the distance Δy_{T,ZM} of a vehicle PE1 to PE3 from a target lane center ZM, on a lane change direction, in particular with respect to a faster/slower lane F1 to F3, and a vehicle class. The lane change duration t_{PE} Δy_{ZM} is determined by averaging across several lane change maneuvers that have a similar distance Δy_{PE,ZM} from the target lane center ZM.

By means of the determined longitudinal acceleration, a model is developed by means of which the collision probability P_{Collision} as a safety measure S1 and the minimum distance d_{x,min} between the vehicle EGO and the other vehicles PE1 to PE3 as a further safety measure S2 can be determined, in particular can be calculated, on the basis of a respective starting situation Δx_{MM,init,PE}_{ᵢ}, Δv_{x,init,PE}_{ᵢ} and which takes into consideration influence possibilities of the vehicle EGO by changing its longitudinal acceleration a_{x,EGO,n}.

Longitudinal acceleration ranges and their probability are used to calculate the collision probability P_{Collision} as a safety measure S1. Here, it is checked which longitudinal accelerations a_{x,PE} of the respective further vehicles PE1 to PE3 lead to a collision with the vehicle EGO during a lane change maneuver into the middle lane F2.

Lane change maneuvers of the vehicle EGO are evaluated based on the starting situation Δx_{MM,init,PE}_{ᵢ}, Δv_{x,init,PE}_{ᵢ} in relation to one or more further vehicles PE1 to PE3 into the right lane F3. This evaluation is described by an initial distance Δx_{MM,init,PE}_{ᵢ} between the two vehicle centers and an initial relative longitudinal speed Δv_{x,init,PE}_{ᵢ}. These two parameters are recorded by means of signals from the surroundings sensor system of the automated, in particular autonomous, vehicle EGO.

Based on the starting situation Δx_{MM,init,PE}_{ᵢ}, Δv_{x,init,PE}_{ᵢ}, a minimum longitudinal acceleration a_{x,PE,min} and a maximum longitudinal acceleration a_{x,PE,max} of the further vehicles PE1 to PE3 are then determined, for which a collision just occurs during a lane change maneuver with a linearized transverse profile of the vehicle EGO and the further vehicles PE1 to PE3. Values within these longitudinal acceleration limits, including the limit values, also lead to a collision.

A necessary longitudinal acceleration range a_{x,PE,min} to a_{x,PE,max} of the further vehicle PE1 to PE3, which leads to a potential collision, can be influenced by the longitudinal acceleration a_{x,EGO}, wherein different longitudinal accelerations a_{x,EGO,n} are depicted by the index n.

A period of time to be considered is defined by a maximum of the lane change duration t_{Ego}, of the vehicle EGO and the further vehicles PE1 to PE3 tₘₐₓ=max(t_{PE}(Δy_{ZM}), t_{Ego}).

In particular, this is because a longer lane change duration provides more time in order to also reduce a higher initial relative longitudinal speed Δv_{x,init,PE}_{ᵢ} and distances with a lower acceleration difference between vehicle EGO and at least one of the further vehicles PE1 to PE3, wherein this represents a more critical case. Such a case is described further below. Moreover, the beginning of the period of time to be considered, within which a collision can occur, is defined by a time t_{EM} of a cutting-in process.

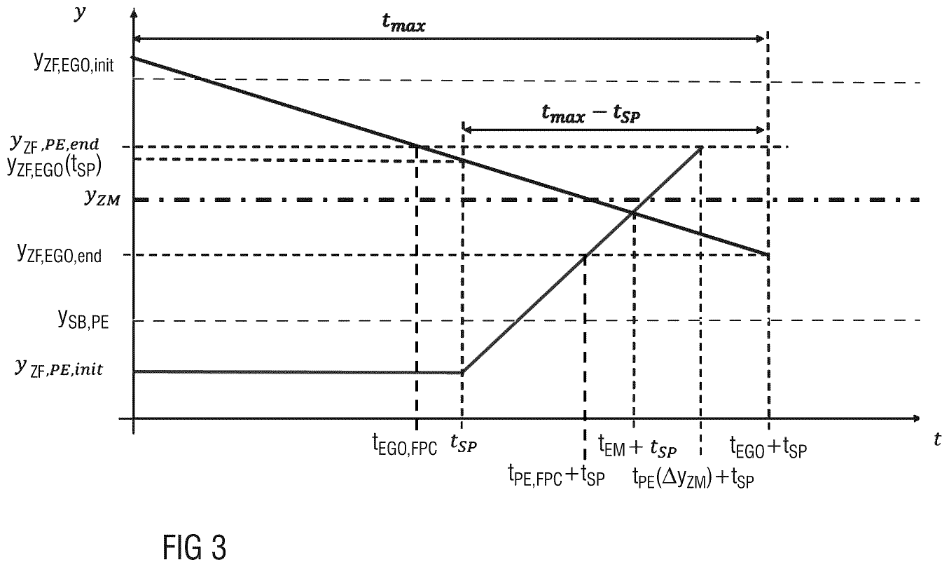

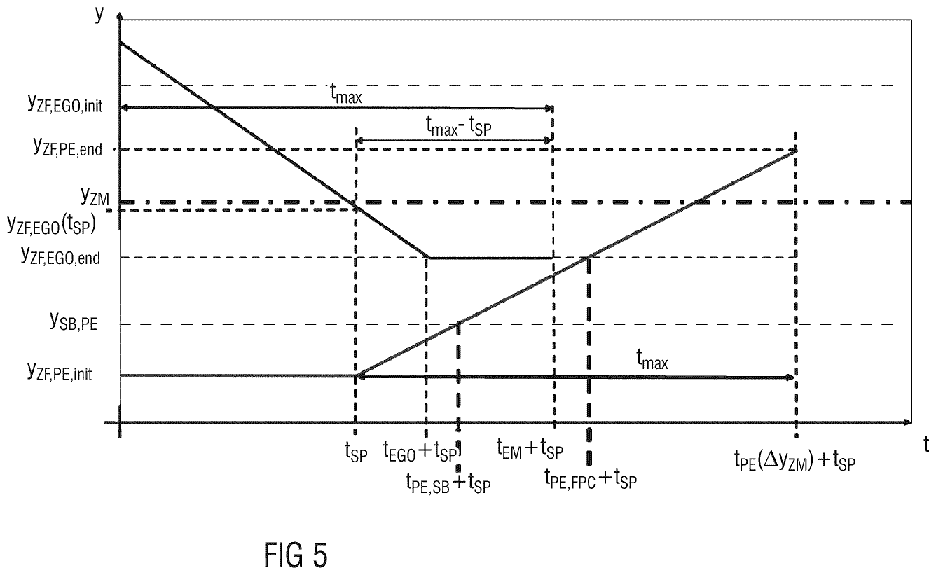

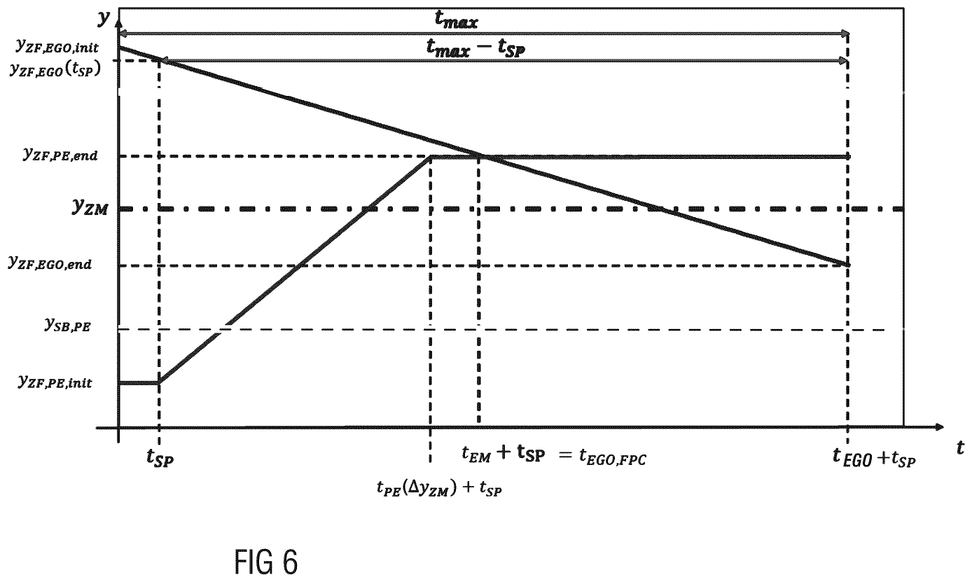

In order to determine the time t_{EM} of the cut-in process of the two vehicles EGO, PE1 to PE3, i.e., the time at which the two vehicle surfaces laterally intersect for the first time, the transverse movements of the vehicle EGO and the corresponding further vehicle PE1 to PE3 are linearized. FIGS. 3 to 6 each illustrate a calculation rule and show four possible cases.

Assuming a constant transverse speed, four possible times t_{EM} for a cutting-in process can be calculated by means of the initial distance Δy_{PE,ZM} to the target lane center ZM.

### Case 1:

An exemplary embodiment shown in FIG. 3 shows possible intersection points of resulting straight lines, which represent the linearized transverse movement of the vehicle sides (ZF) facing towards the vehicle.

If the two vehicle surfaces overlap before the end of one of the two lane change maneuvers, then the following applies:

$${t}_{E M} = \frac{\vert {y}_{ZF , Ego} ( {t}_{SP} ) - {y}_{ZF , PE , init} \vert}{\vert {v}_{y , Ego} + {v}_{y , PE} \vert} \qquad ( 3 )$$

### Condition:

$$( {t}_{E G O} = \frac{\vert {y}_{ZF , Ego , End} - {y}_{ZF , Ego} ( {t}_{SP} ) \vert}{\vert {v}_{y , Ego} \vert} \geq {t}_{PE , FPC} = \frac{\vert {y}_{ZF , Ego , E n d} - {y}_{ZF , PE , init} \vert}{\vert {v}_{y P E} \vert} ) ∧ \qquad ( 4 )$$

$$( {t}_{PE} ( Δ {y}_{ZM} ) = \frac{\vert {y}_{ZF , PE , End} - {y}_{ZF , PE , init} \vert}{\vert {v}_{y , PE} \vert} + {t}_{SP} > {t}_{EGO , FPC} = \frac{{y}_{ZF , Ego , init} - {y}_{ZF , PE , End}}{\vert {v}_{y , EGO} \vert} )$$

Here, t_{SP} describes a shift in the lane change start of the corresponding further vehicle PE1 to PE3. Assuming that there are lane change maneuvers that cannot be recognized in the context, the corresponding further vehicle PE1 to PE3 can decide to also change into lane F1 to F3 at any possible time during the lane change maneuver of the vehicle EGO.

By shifting t_{SP} of the lane change start of the corresponding further vehicle PE1 to PE3 to a later time, the period to be considered is shortened.

A starting position and relative speed is calculated as follows:

$$Δ {x}_{MM} ( {t}_{S P} ) = Δ {x}_{MM , init , {PE}_{i}} + Δ {v}_{x , init , {PE}_{i}} {t}_{SP} + \frac{1}{2} ( {a}_{x , Ego , n} - {a}_{x , {PE}_{{i}^{}} , init} ) {t}_{S P}^{2} \qquad ( 5 )$$

$$Δ {v}_{x} ( {t}_{S P} ) = Δ {v}_{x , init , {PE}_{i}} + ( {a}_{, Ego , n} - {a}_{x , {PE}_{i} , init} ) {t}_{SP} \qquad ( 6 )$$

It is assumed that the initial longitudinal acceleration a_{x,PE}_{ᵢ}_{,init} of further vehicles PE1 to PE3 cannot be measured exactly or only inaccurately and is assumed to be zero for the method described here.

$${y}_{ZF , EGO} ( {t}_{SP} ) = {y}_{ZF , EGO , init} + {v}_{y , EGO} {t}_{SP} \qquad ( 7 )$$

$${t}_{S P} ∈ [ 0 , {t}_{max} - \frac{\vert {y}_{SB , PE} - {y}_{ZF , PE , init} \vert}{\vert {v}_{y , PE} \vert} \qquad ( 8 )$$

A first possible contact between the vehicle EGO and the corresponding further vehicle PE1 to PE3 is also shown in FIG. 3.

### Case 2:

If the corresponding further vehicle PE1 to PE3 reaches a lateral end position of the vehicle EGO after the vehicle EGO has finished its transverse movement, but before the end of the considered period tₘₐₓ−t_{SP} then the following applies:

$${t}_{E M} = \frac{\vert {y}_{ZF , Ego , End} - {y}_{ZF , PE , init} \vert}{\vert {v}_{y , PE} \vert} \qquad ( 9 )$$

### Condition:

$$( {t}_{PE} ( Δ {y}_{ZM} ) > {t}_{Ego} ) ∧ ( {t}_{max} - {t}_{SP} \geq {t}_{PE , FPC} = \frac{\vert {y}_{ZF , Ego , End} - {y}_{ZF , PE , init} \vert}{\vert {v}_{y , PE} \vert} \geq {t}_{EGO} = \frac{\vert {y}_{ZF , Ego , End} - {y}_{ZF , Ego} ( {t}_{SP} ) \vert}{\vert {v}_{y , Ego} \vert} ) \qquad ( 10 )$$

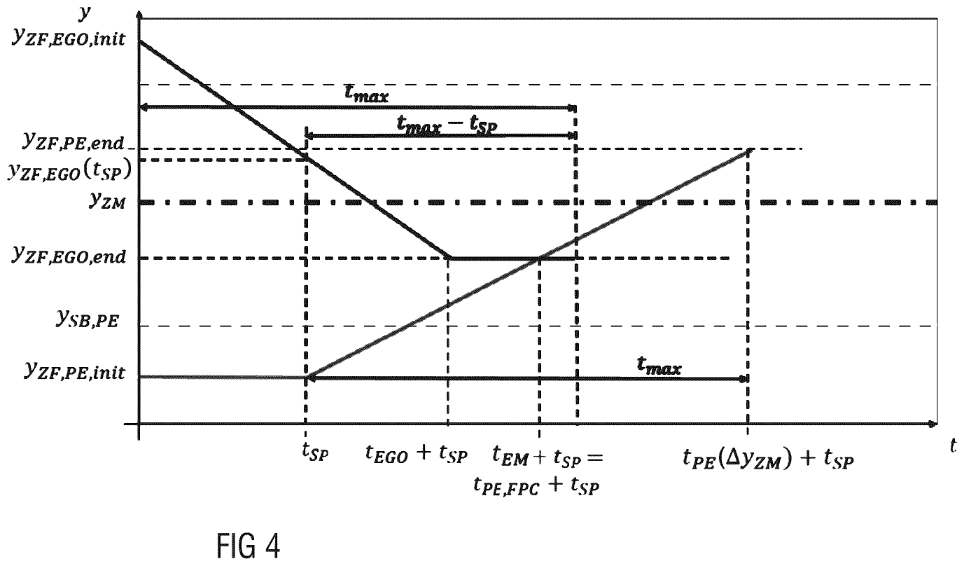

as is shown in the exemplary embodiment in FIG. 4.

### Case 3:

If the corresponding further vehicle PE1 to PE3 reaches the lateral end position only after the end of the considered period (tₘₐₓ−t_{SP}), but still reaches the lane boundary (y_{SB,PE}) of the target lane ZS within the considered period (tₘₐₓ−t_{SP}), then the following applies:

$${t}_{EM} = {t}_{max} - {t}_{SP} \qquad ( 11 )$$

### Condition:

$${t}_{PE , FPC} = \frac{\vert {y}_{ZF , Ego , End} - {y}_{ZF , PE , init} \vert}{\vert {v}_{y , PE} \vert} > {t}_{max} - {t}_{SP} \geq {t}_{PE , SB} = \frac{\vert {y}_{SB , PE} - {y}_{ZF , PE , init} \vert}{\vert {v}_{y , PE} \vert} .$$

Although there is no actual overlap between vehicle surfaces, the presence of the two vehicles EGO, PE1 to PE3 next to each other in the same lane F2 is considered critical and therefore counted as an overlap.

### Case 4:

If the corresponding further vehicle PE1 to PE3 reaches its lateral end position y_{ZF,PE,end} before the vehicle EGO reaches a lateral end position y_{ZF,EGO,end} of the corresponding further vehicle PE1 to PE3, then the following applies:

$${t}_{E M} = \frac{\vert {y}_{ZF , Ego} ( {t}_{SP} ) - {y}_{ZF , PE , End} \vert}{\vert {v}_{y , Ego} \vert} \qquad ( 12 )$$

### Condition:

$${t}_{EGO , FPC} - {t}_{S P} = \frac{\vert {y}_{ZF , Ego , init} - {y}_{ZF , PE , End} \vert}{\vert {v}_{y , EGO} \vert} - {t}_{SP} \geq {t}_{PE} ( Δ {y}_{ZM} ) = \frac{\vert {y}_{ZF , PE , End} - {y}_{ZF , PE , init} \vert}{\vert {v}_{y , PE} \vert} \qquad ( 13 )$$

With equation (13) case 4 is completed.

Using the following calculation rule, a minimum longitudinal acceleration a_{x,PE}_{ᵢ}_{,min} and a maximum longitudinal acceleration a_{x,PE}_{ᵢ}_{,max} of the corresponding further vehicle PE1 to PE3 are determined. Values within these limits, including limit values, lead to a collision for a given starting situation a_{x,PE}_{ᵢ}_{,max}, Δv_{x,init,PE}_{ᵢ}:

### Acceleration Difference Limiting Cases:

$$Δ {a}_{Gf , {t}_{max}} = - \frac{Δ {v}_{x} ( {t}_{SP} )}{{t}_{max} - {t}_{SP}} ; Δ {a}_{Limiting case , {t}_{EM}} = - \frac{Δ {v}_{x} ( {t}_{SP} )}{{t}_{E M}} \qquad ( 14 )$$

### Start Position Limiting Cases (Gf):

$$Δ {x}_{MM , G , f , {t}_{max}} = \{ \begin{matrix}\frac{1}{2} Δ {{a}_{Gf , {t}_{max}} ( {t}_{max} - {t}_{SP} )}^{2} - L for Δ {v}_{x} ( {t}_{SP} ) \geq 0 \\ \frac{1}{2} Δ {{a}_{Gf , {t}_{max}} ( {t}_{max} - {t}_{SP} )}^{2} + L for Δ {v}_{x} ( {t}_{SP} ) < 0\end{matrix} \qquad ( 15 )$$

$$Δ {x}_{MM , G , f , {t}_{EM}} = \{ \begin{matrix}\frac{1}{2} Δ {a}_{Gf , {t}_{max}} {t}_{EM}^{2} - L & for Δ {v}_{x} ( {t}_{SP} ) \geq 0 \\ \frac{1}{2} Δ {a}_{Gf , {t}_{max}} {t}_{EM}^{2} + L & for Δ {v}_{x} ( {t}_{SP} ) < 0\end{matrix} \qquad ( 16 )$$

$$Δ {x}_{MM , {a}_{min , equal}} = - Δ {v}_{x} ( {t}_{S P} ) \frac{{t}_{EM}}{1 + \frac{{t}_{EM}}{{t}_{max} - {t}_{SP}}} + L for Δ {v}_{x} ( {t}_{S P} ) \geq 0 ; \qquad ( 17 )$$

$$Δ {x}_{MM , {a}_{max , equal}} = - Δ {v}_{x} ( {t}_{S P} ) \frac{{t}_{EM}}{1 + \frac{{t}_{EM}}{{t}_{max} - {t}_{SP}}} + L for Δ {v}_{x} ( {t}_{S P} ) < 0 \qquad ( 18 )$$

$$with : L = \frac{{l}_{EGO} + {l}_{{PE}_{i}}}{2} , {l}_{EGO} = vehicle length EGO ,$$

$${l}_{{PE}_{i}} = vehicle length PE 1 to PE 3$$

$$Δ {x}_{MM , {t}_{max}} = Δ {x}_{MM} ( {t}_{SP} ) + Δ {v}_{x} ( {t}_{SP} ) ( {t}_{max} - {t}_{SP} ) + \frac{1}{2} {{a}_{x , Ego , n} ( {t}_{max} - {t}_{SP} )}^{2} ; \qquad ( 19 )$$

$$Δ {x}_{MM , {t}_{EM}} = Δ {x}_{MM} ( {t}_{SP} ) + Δ {v}_{x} ( {t}_{SP} ) {t}_{EM} + \frac{1}{2} {a}_{x , Ego , n} {t}_{EM}^{2} \qquad ( 20 )$$

$${a}_{x , {PE}_{i} , max} = \{ \begin{matrix}\frac{2 ( Δ {x}_{MM , {t}_{max}} + L )}{{( {t}_{max} - {t}_{SP} )}^{2}} & \begin{matrix}f \ddot{u} r ( Δ {x}_{MM} ( {t}_{SP} ) < Δ {x}_{MM , Gf , {t}_{max}} ∧ \\ Δ {v}_{x} ( {t}_{SP} ) \geq 0 ) \\ ∨ ( Δ {x}_{MM} ( {t}_{SP} ) \leq Δ {x}_{MM , {a}_{max , equal}} ∧ \\ Δ {v}_{x} ( {t}_{SP} ) < 0 )\end{matrix} & ( 21 a ) \\ \begin{matrix}{a}_{x , Ego , n} - \\ \frac{1}{2} \frac{Δ {v}_{x}^{2} ( {t}_{SP} )}{Δ {x}_{MM} ( {t}_{SP} ) + L}\end{matrix} & \begin{matrix}f \ddot{u} r Δ {x}_{MM , Gf , {t}_{max}} \leq Δ {x}_{MM} ( {t}_{SP} ) \leq \\ Δ {x}_{MM , Gf , {t}_{EM}} \\ ∧ Δ {v}_{x} ( {t}_{SP} ) \geq 0\end{matrix} & ( 21 b ) \\ \frac{2 ( Δ {x}_{MM , {t}_{EM}} + L )}{{t}_{EM}^{2}} & \begin{matrix}f \ddot{u} r ( Δ {x}_{MM , Gf , {t}_{EM}} < Δ {x}_{MM} ( {t}_{SP} ) ∧ \\ Δ {v}_{x} ( {t}_{SP} ) \geq 0 ) \\ ∨ ( Δ {x}_{MM , {a}_{max , equal}} < Δ {x}_{MM} ( {t}_{SP} ) ∧ \\ Δ {v}_{x} ( {t}_{SP} ) < 0 )\end{matrix} & ( 21 c )\end{matrix}$$

$${a}_{x , {PE}_{i} , min} = \{ \begin{matrix}\frac{2 ( Δ {x}_{MM , {t}_{max}} + L )}{{( {t}_{max} - {t}_{SP} )}^{2}} & \begin{matrix}f \ddot{u} r ( Δ {x}_{MM , Gf , {t}_{max}} \leq Δ {x}_{MM} ( {t}_{SP} ) ∧ \\ Δ {v}_{x} ( {t}_{SP} ) < 0 ) \\ ∨ ( Δ {x}_{MM , {a}_{max , equal}} \leq Δ {x}_{MM} ( {t}_{SP} ) ∧ \\ Δ {v}_{x} ( {t}_{SP} ) \geq 0 )\end{matrix} & ( 22 d ) \\ \begin{matrix}{a}_{x , Ego , n} - \\ \frac{1}{2} \frac{Δ {v}_{x}^{2} ( {t}_{SP} )}{Δ {x}_{MM} ( {t}_{SP} ) - L}\end{matrix} & \begin{matrix}f \ddot{u} r Δ {x}_{MM , Gf , {t}_{EM}} \leq Δ {x}_{MM} ( {t}_{SP} ) \leq \\ Δ {x}_{MM , Gf , {t}_{max}} \\ ∧ Δ {v}_{x} ( {t}_{SP} ) < 0\end{matrix} & ( 22 e ) \\ \frac{2 ( Δ {x}_{MM , {t}_{EM}} - L )}{{t}_{EM}^{2}} & \begin{matrix}f \ddot{u} r ( Δ {x}_{MM} ( {t}_{SP} ) < Δ {x}_{MM , Gf , {t}_{EM}} ∧ \\ Δ {v}_{x} ( {t}_{SP} ) < 0 ) \\ ∨ ( Δ {x}_{MM} ( {t}_{SP} ) < Δ {x}_{MM , {a}_{min , equal}} ∧ \\ Δ {v}_{x} ( {t}_{SP} ) \geq 0 )\end{matrix} & ( 22 f )\end{matrix}$$

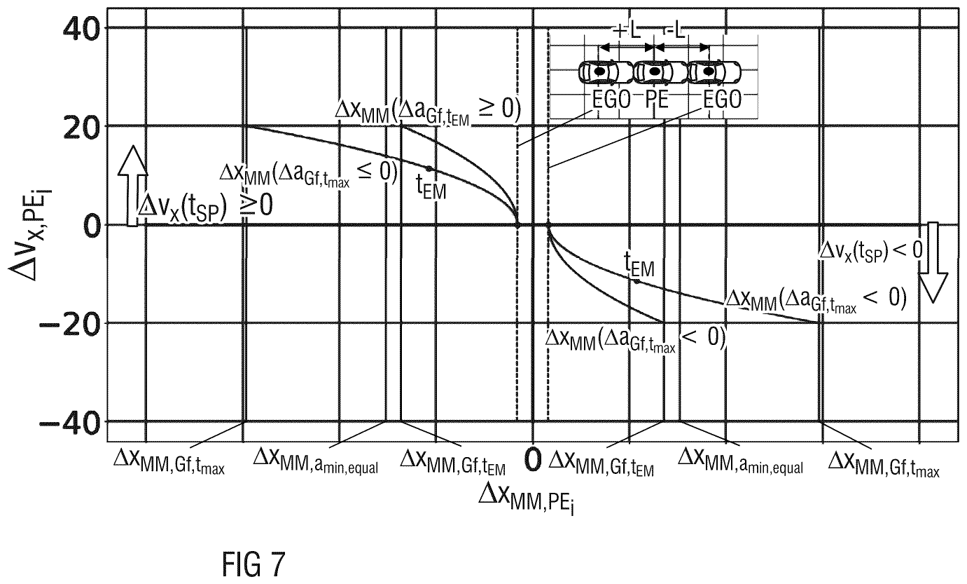

FIG. 7 shows explanations of the calculation rule.

An acceleration limit case is an acceleration difference Δa_{Gf,t}_{ₘₐₓ}_{/t}_{_{EM}}, with which the relative speed Δvₓ(t_{SP}) is completely reduced at the time t_{SP} at the end of the lane change or at the time t_{EM} at the cutting-in process.

Depending on the sign of the relative speed Δvₓ(t_{SP}) at time t_{SP}, the initial limiting distance Δx_{MM,Gf,t}_{ₘₐₓ}_{/t}_{_{EM}} of the vehicle centers can be calculated, which would be necessary so that, at a given relative speed Δvₓ(t_{SP}), a last point of approach before the vehicles EGO, PE1 to PE3 would move away from each other again, is a touch of the bumpers.

If the distance Δx_{MM}(t_{SP}) of the vehicle centers at time t_{SP} is between the limits determined in equations (15) and (16), then a differential acceleration is sought for which the bumpers of the vehicles EGO, PE1 to PE3 touch (Δx_{SS,t}=0) before the vehicles EGO, PE1 to PE3 move away from each other again. This case is given when:

$$Δ {x}_{S S , t} = Δ {x}_{M M , i n i t} ( {t}_{S P} ) \pm L + Δ {v}_{x} ( {t}_{S P} ) t + \frac{1}{2} ( {a}_{x , E g o , n} - {a}_{x , P E} ) {t}^{2} ; \qquad ( 23 )$$

$$t ∈ {t}_{E M} , ( {t}_{max} - {t}_{S P} )$$

solving for t yields only one solution. This is the case when the square root of the solution for quadratic equations of the form ax²+bx+c=0 is zero. The calculation for a time of contact of the bumpers Δx_{SS,t} here lies between the time t_{EM} of the cutting-in maneuver and the end of the lane change maneuver and is calculated for each shift t_{SP} of the starting time.

Depending on a sign of the relative speed Δvₓ(t_{SP}) at time t_{SP}, the number of possible cases in equations (21) and (22) changes. For a positive relative speed Δvₓ(t_{SP}), the maximum longitudinal acceleration a_{x,PE}_{ᵢ}_{,max} is determined by equations (21a), (21b), or (21c), while the minimum longitudinal acceleration a_{x,PE}_{ᵢ}_{,min} is determined only by equation (22d) or (22f). For a negative relative speed Δvₓ(t_{SP}), the opposite is true, wherein the maximum longitudinal acceleration a_{x,PE}_{ᵢ}_{,max} is determined by equation (21a) or (21c). Equation (17) for the limiting case position for the minimum longitudinal acceleration a_{x,PE}_{ᵢ}_{,min} at positive relative speed Δvₓ(t_{SP}) is obtained by equating equations (22d) and (22f), or equation (18) for the limiting case position for the maximum longitudinal acceleration a_{x,PE}_{ᵢ}_{,max} at negative relative velocity Δvₓ(t_{SP}) is obtained by equating the equations (21a) and (21c).

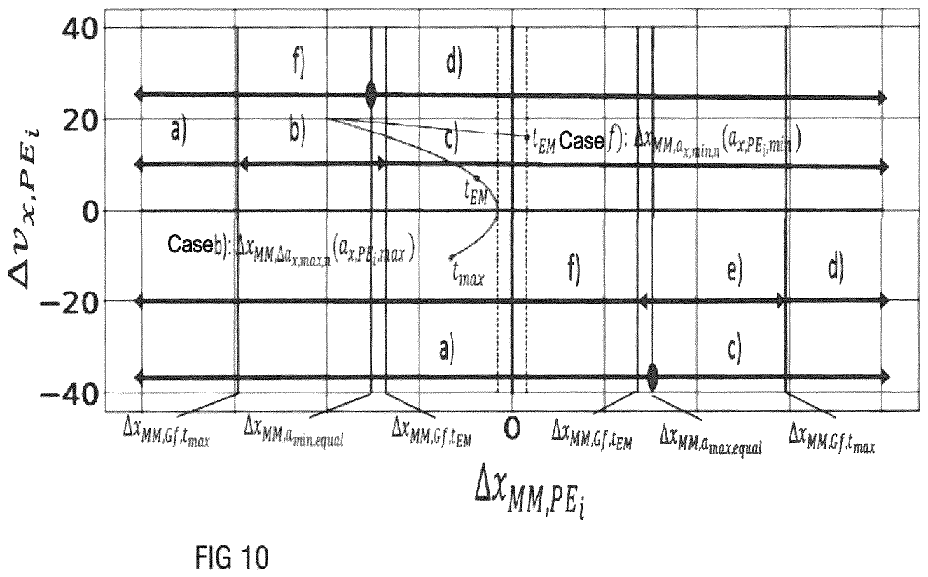

FIG. 10 illustrates the limiting case positions from equations (15) to (18) and individual regions from equations (21a-c) and (22d-f).

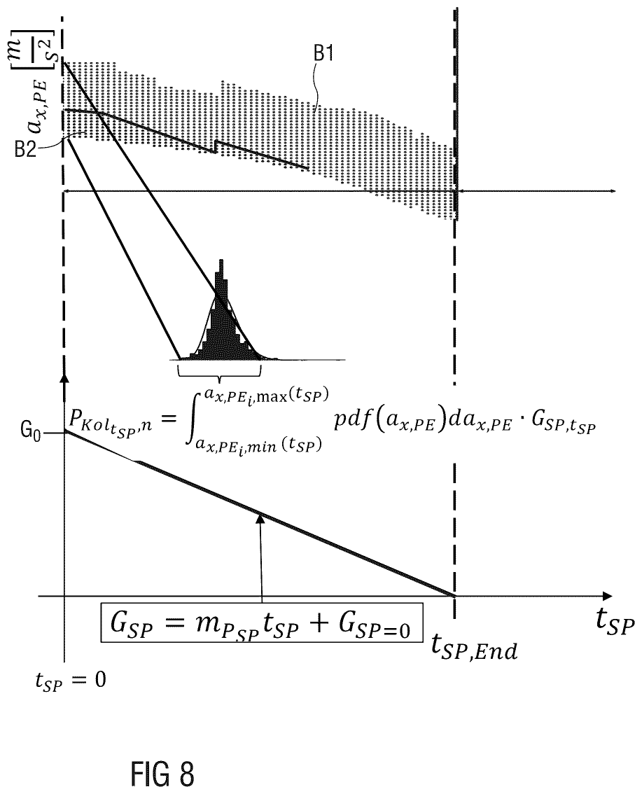

The determined longitudinal acceleration values a_{x,PE,min} and a_{x,PE,max} from the equations (21a) to (21c) and (22d) to (22f) are then used as integral limits, as shown in FIG. 8, in the calculation of the collision probability P_{Collision} as a safety measure S1. For this purpose, the probability density function pdf determined at an earlier time is integrated. The collision probability P_{Collision} is weighted depending on the displacement t_{SP}, wherein the weighting is defined by a straight line G_{SP,t}_{_{SP}} shown in FIG. 8. In particular, FIG. 8 shows a derivation of the collision probability P_{Collision} as safety measure S1.

The rationale for the weighting line is: The later the lane change maneuver begins for the corresponding further vehicle PE1 to PE3, the less time is available in order to complete the lane change maneuver, whereby the risk of a collision reduces. Furthermore, it can be assumed that as the lane change maneuver of vehicle EGO progresses, the probability that a lane change will be started by further vehicles PE1 to PE3 also reduces, since the probability that the movement of vehicle EGO will be perceived by further vehicles PE1 to PE3 increases. Subsequently, the weighted individual collision probabilities are summed to form an overall collision probability P_{GKol,PE}_{ᵢ}_{,n}. The overall collision probability P_{GKol,PE}_{ᵢ}_{,n} can also be calculated without a weighting line and used as safety measure S1.

$${P}_{G K o l , P {E}_{i} , n} = {\sum }_{{t}_{S P} = 0}^{{t}_{SP , End}} {\int }_{{a}_{x P {E}_{i} , min} ( {t}_{S P} )}^{{a}_{x , {PE}_{i} , max} ( {t}_{S P )}} pdf ( {a}_{x , PE} ) d {a}_{x , PE} \cdot {G}_{SP , {t}_{SP}} \qquad ( 24 )$$

In an upper region of FIG. 8, two regions B1 and B2 are shown with different hatching. A first region B1 here represents possible transverse collisions due to overlapping vehicle surfaces between the vehicle EGO and a corresponding further vehicle PE1 to PE3.

A lower region B2 represents a possible occurrence of longitudinal collisions between the vehicle EGO and the corresponding further vehicle PE1 to PE3.

By means of the straight line G_{SP,t}_{_{SP}}, a surface

$${A}_{G} = 1 = \frac{1}{2} {G}_{0} {t}_{SP , End}$$

is formed below it. In addition, an intersection point with the abscissa is set by means of a last relevant starting time t_{SP,End} for the lane change of the corresponding further vehicle PE1 to PE3. This last relevant starting time t_{SP,End} represents a time at which the corresponding further vehicle PE1 to PE3 begins its lane change maneuver and at which time is sufficient to touch the lane boundary SB of the target lane ZS with the vehicle surface facing towards the vehicle EGO.

An intersection point Go with the ordinate axis results from a requirement for the area

$${A}_{G} = 1 = \frac{1}{2} {G}_{0} {t}_{SP , End}$$

below the straight lines G_{SP,t}_{_{SP}} to G_{SP,t}_{_{SP}}. A gradient m_{G}_{_{SP}} of the straight line G_{SP,t}_{_{SP}} is determined as follows:

$${m}_{{G}_{S P}} = - \frac{{G}_{0}}{{t}_{SP , End}} \qquad ( 25 )$$

The total collision probability of all PEs is then summed (AGKol=accumulated GKol, n_{PE}=number of potential cut-ins).

$${P}_{AGKo , PE , n} = {\sum }_{i = 1}^{{n}_{P E}} {P}_{G K o l , P {E}_{i} , n} \qquad ( 26 )$$

The total collision probability P_{AGKol,PE,n} can be integrated into any cost function of a trajectory planning in order to calculate the optimal longitudinal acceleration a_{x,EGO} under various requirements and/or restrictions with regard to engine size, static friction coefficient, comfort requirements, legal requirements, etc. If the calculated acceleration effort of the vehicle EGO, which would be necessary to exclude a potential collision, has a detrimental impact on other requirements, it is also possible to perform the lane change maneuver at a later time, when the starting situation for performing a safe lane change maneuver has changed.

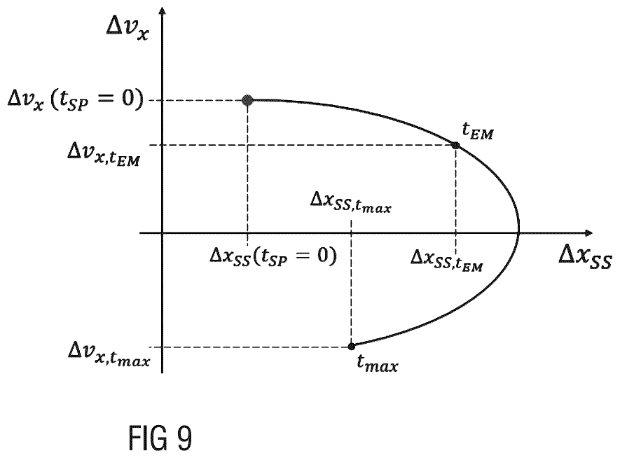

FIG. 9 shows a depiction of a relative longitudinal distance profile of the vehicle bumpers for calculating a minimum distance d_{x,min} between the vehicle EGO and the corresponding further vehicle PE1 to PE3, when no collision occurs between them.

If no collision occurs, then the minimum distance d_{x,min}, also referred to as the minimum longitudinal distance, is used as additional safety measure S2. Here, the minimum distance d_{x,min} is either at the moment of cutting-in t_{EM} or at the moment of the maximum lane change duration tₘₐₓ.

In particular, FIG. 9 shows the relationship between the minimum distance d_{x,min} and the relative longitudinal speed Δvₓ(t_{SP}=0) during the lane change maneuver.

The shift t_{SP} of the starting time for initiating the lane change maneuver of the corresponding further vehicle PE1 to PE3 is here set to zero, since when both lane change maneuvers start simultaneously, most of the time is available in order to reduce a relative longitudinal distance.

The distance between the two facing vehicle bumpers at the moment of cutting in and the time of the maximum lane change duration emerges depending on the most critical acceleration of the corresponding further vehicle PE1 to PE3 depending on the starting situation Δx_{MM,init,PE}_{ᵢ}, Δv_{x,init,PE}_{ᵢ}:

$$Δ {a}_{x , data , max , n} = {a}_{x , Ego , n} - {a}_{x , PE , data , max} ; \qquad ( 27 )$$

$$Δ {a}_{x , data , min , n} = {a}_{x , Ego , n} - {a}_{x , PE , data , min}$$

$$Δ {x}_{SS , {t}_{E M} , Δ {a}_{x , max}} = Δ {x}_{MM , init , {PE}_{i}} - L + Δ {v}_{x , init , {PE}_{i}} {t}_{EM} + \frac{Δ {a}_{x , data , max , n}}{2} {t}_{EM}^{2} \qquad ( 28 )$$

$$Δ {x}_{SS , {t}_{max} , Δ {a}_{x , max}} = Δ {x}_{MM , init , {PE}_{i}} - L + Δ {v}_{x , init , {PE}_{i}} {t}_{max} + \frac{Δ {a}_{x , data , max , n}}{2} {t}_{max}^{2} \qquad ( 29 )$$

$$Δ {x}_{SS , {t}_{E M} , Δ {a}_{x , min}} = Δ {x}_{MM , init , {PE}_{i}} + L + Δ {v}_{x , init , {PE}_{i}} {t}_{EM} + \frac{Δ {a}_{x , data , min , n}}{2} {t}_{EM}^{2} \qquad ( 30 )$$

$$Δ {x}_{SS , {t}_{max} , Δ {a}_{x , min}} = Δ {x}_{MM , init , {PE}_{i}} + L + Δ {v}_{x , init , {PE}_{i}} {t}_{max} + \frac{Δ {a}_{x , data , min , n}}{2} {t}_{max}^{2} \qquad ( 31 )$$

A minimum of the minimum distance d_{x,min} then results depending on the case distinction from:

$$( 32 )$$

$${d}_{x , min , n} = \{ \begin{matrix}min ( \vert Δ {x}_{SS , {t}_{EM} , Δ {a}_{x , min}} \vert , \vert Δ {x}_{SS , {t}_{max} , Δ {a}_{x , min}} \vert ) , for {a}_{x , {PE}_{i} , max} < {a}_{x , PE , data , min} \\ 0 , for {a}_{x , PE , data , min} \leq {a}_{x , PE , , min} \leq {a}_{x , PE , data , max} \\ ∨ {a}_{x , PE , data , min} \leq {a}_{x , {PE}_{i} , max} \leq {a}_{x , PE , data , max} \\ min ( \vert Δ {x}_{SS , {t}_{EM} , Δ {a}_{x , max}} \vert , \vert Δ {x}_{SS , {t}_{max} , Δ {a}_{x , max}} \vert ) , for {a}_{x , {PE}_{i} , min} > {a}_{x , PE , data , max}\end{matrix}$$

The method enables a safety assessment for an automated driving, in particular autonomously driving, vehicle EGO.

By changing the longitudinal acceleration a_{x,EGO,n} of the EGO vehicle, the longitudinal accelerations a_{x,PE} of the further vehicles PE1 to PE3 as potential mergers, which would be necessary for a collision, can be shifted in such a way that they are outside a critical range that has been determined by means of real-world driving data. The EGO vehicle is thus able to reduce the risk of a collision even before a lane change maneuver into the center lane F2 or to deliberately postpone the start of the lane change maneuver, whereby the degree of safety for the EGO vehicle and the further vehicles PE1 to PE3 can be increased.

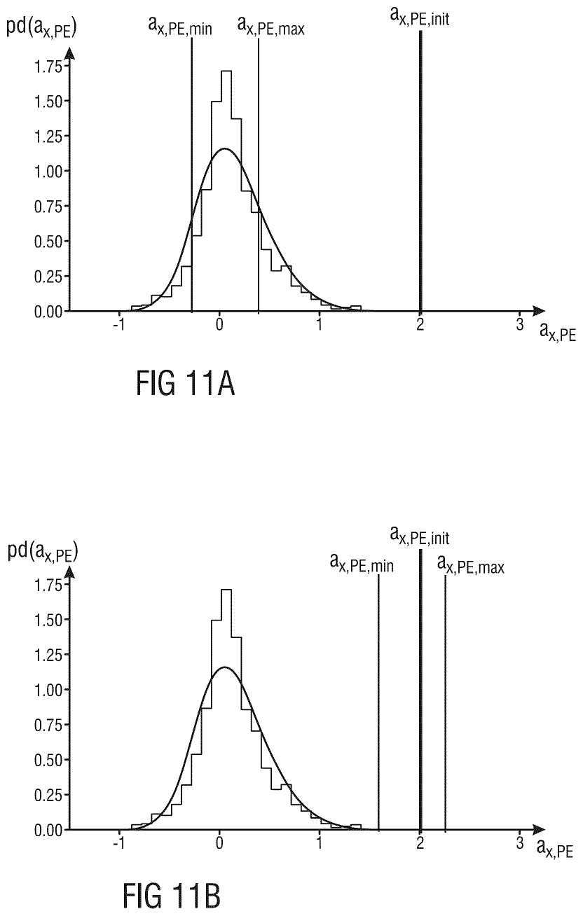

In FIG. 11A, a diagram with a collision probability density pd (a_{x,PE}) without taking into consideration a jerk j and a further diagram with a shifted collision probability density range by adjusting a longitudinal acceleration a_{x,EGO} of the vehicle EGO is depicted.

As described above, it is assumed here that the initial longitudinal acceleration a_{x,PE}_{ᵢ}_{,init}a_{x,PE}_{ᵢ}_{,init} of the further vehicles PE1 to PE3 cannot be measured exactly or only inaccurately and is assumed to be zero for the method described here.

Furthermore, the aim of the method is to shift the longitudinal acceleration limits a_{x,PE,min}, a_{x,PE,max} of the further vehicles PE1 to PE3 into a range of lower probability by adjusting a longitudinal speed of the vehicle EGO in order to thus minimize the collision probability P_{Collision}.

For this purpose, it has been defined that a probability of occurrence of the respective longitudinal accelerations a_{x,PE} which leads to a collision simultaneously describes the collision probability P_{Collision} or corresponds to the collision probability P_{Collision}, since the longitudinal acceleration a_{x,PE} is directly related to an overlap of the vehicle surfaces and thus to a collision.

Here, a problem described by means of FIGS. 11A and 11B emerges.

However, when the initial longitudinal acceleration a_{x,PE}_{ᵢ}_{,init} of one of the further vehicles PE1 to PE3 is already in a range of low occurrence probabilities, it may happen that an optimization of the longitudinal acceleration a_{x,EGO} of the vehicle EGO shifts the longitudinal acceleration limits a_{x,PE,min}, a_{x,PE,max} of the further vehicle PE1 to PE3 into a range which, due to its low probability, is optimal from a statistical point of view with regard to the longitudinal acceleration a_{x,EGO}, but due to an actual, in particular measured, initial situation Δx_{MM,init,PE}_{ᵢ}, Δv_{x,init,PE}_{ᵢ} contains the starting longitudinal acceleration a_{x,PE}_{ᵢ}_{,init} of the further vehicle PE1 to PE3 or approaches it and thus there is a risk of a collision, should the further vehicle PE1 to PE3 exceed the initial longitudinal acceleration a_{x,PE}_{ᵢ}_{,init} averaged over a lane change.

According to FIG. 11A, the collision probability P_{Collision} is calculated as follows:

$${P}_{Collision} = {\int }_{{a}_{x , PE , min}}^{{a}_{x , PE , max}} pdf ( {a}_{x , PE} ) d {a}_{x , PE} \approx 0 , 5 = 50 \% \qquad ( 33 )$$

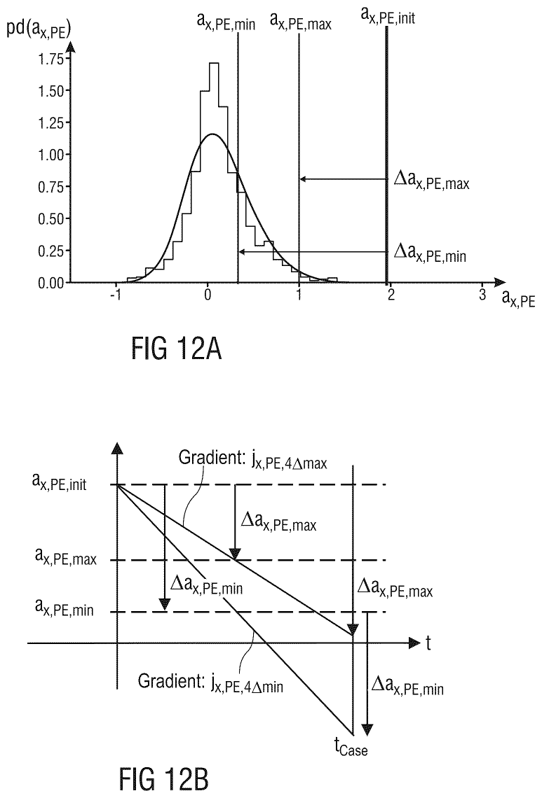

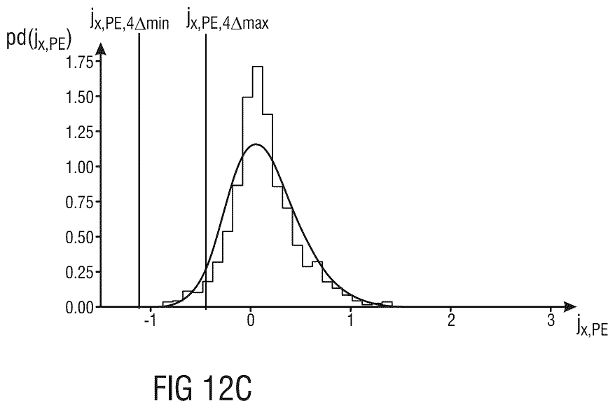

without taking into consideration the jerk j, whereas the collision probability P_{Collision} taking into consideration a jerk j described in FIGS. 12A to 12C is ≈0.

FIG. 11B shows a further diagram in which the probability density pd(a_{x,PE}) is shifted by adjusting the longitudinal acceleration a_{x,EGO}.

The collision probability P_{Collision} is calculated according to the method described above as follows:

$${P}_{Collision} = {\int }_{{a}_{x , PE , min}}^{{a}_{x , PE , max}} pdf ( {a}_{x , PE} ) d {a}_{x , PE} \approx 0 \qquad ( 34 )$$

and according to a new solution approach ≈50%.

FIGS. 12a to 12c show an alternative or additional solution approach for determining a collision probability P_{Collision} taking into consideration the jerk j for a longitudinal acceleration a_{x,PE} of the further vehicles PE1 to PE3. The jerk j represents an instantaneous temporal rate of change of an acceleration a.

Assuming that the initial longitudinal acceleration a_{x,PE}_{ᵢ}_{,init} of the further vehicle PE1 to PE3 can be measured with sufficient accuracy, a difference between the initial longitudinal acceleration a_{x,PE}_{ᵢ}_{,init} and the two longitudinal acceleration limits a_{x,PE,min}, a_{x,PE,max} can be determined, in particular calculated.

By means of these differences, the minimum jerk j_{x;PE4Δmin} and the maximum jerk j_{x,PE,4Δmax} can be calculated, which must be applied, averaged over the lane change, for the further vehicle PE1 to PE3 to enter the region of the potential collision. This calculation is illustrated in FIGS. 12A and 12B.

The maximum jerk j_{x,PE,max} is calculated as follows:

$${j}_{x , PE , 4 Δ max} = 2 \frac{{a}_{x , PE , max} - {a}_{x , PE , init}}{{t}_{F a l l}} = 2 \frac{Δ {a}_{x , PE , max}}{{t}_{F a l l}} \qquad ( 35 )$$

t_{Fall}∈tₘₐₓ, t_{EM} depending on the calculation case (21a) to (21c) and (22d) to (22f) for calculating the longitudinal acceleration limits a_{x,PE,min}, a_{x,PE,max}.

The minimum jerk j_{x,PE,min} is calculated as follows:

$${j}_{x , PE , 4 Δ min} = 2 \frac{{a}_{x , PE , min} - {a}_{x , PE , init}}{{t}_{F a l l}} = 2 \frac{Δ {a}_{x , PE , min}}{{t}_{F a l l}} \qquad ( 36 )$$

t_{Fall}∈tₘₐₓ, t_{EM} depending on the calculation case (21a) to (21c) and (22d) to (22f) for calculating the longitudinal acceleration limits a_{x,PE,min}, a_{x,PE,max}.

Using a data set, longitudinal jerk ranges are determined from mean values of the longitudinal acceleration change during a lane change using the same method as in the method steps described above, and their probability of occurrence is described via a probability density function, as shown in FIG. 12C.

The determined values for the maximum jerk j_{x,PE,4Δmax} and the minimum jerk j_{x,PE,4Δmin} are then used as integral limits for the probability density function of the jerk j when calculating the collision probability P_{Collision}.

In comparison to the method steps described above, this solution approach also takes the jerk j into consideration when calculating the collision probability P_{Collision}. The longitudinal acceleration a_{x,EGO} of the vehicle EGO can thus be optimized in such a way that the minimum longitudinal acceleration a_{x,PE,min} and the maximum longitudinal acceleration of the further vehicles PE1 to PE3 require a longitudinal acceleration change effort that has a statistically low probability of occurrence and thus a low collision probability.

Unlike described above, the probability of occurrence of the jerk j, which is required in order to achieve an average acceleration that then leads to a collision, is used as the collision probability P_{Collision} and not the probability of occurrence of the longitudinal acceleration a_{x,PE}.

1.-3. (canceled)

4. A method for a safety assessment of a lane change maneuver in an automated driving operation of a vehicle (EGO) with a surroundings sensor system, wherein a surroundings of the vehicle (EGO) and objects located in the surroundings are detected by signals recorded by the surroundings sensor system, the method comprising the steps of:
before a lane change maneuver of the vehicle (EGO) from a left lane (F1) to a center lane (F2) or from a right lane (F3) to the center lane (F2) of a multi-lane roadway section (F), determining a collision risk by hypothetical lane change maneuvers of further vehicles (PE1 to PE3) in the right lane (F3) or the left lane (F1);
based on a maximum lane change duration and a cut-in moment (t_{EM}), determining longitudinal accelerations (a_{x,PE}) of the further vehicles (PE1 to PE3) that could lead to a collision due to an overlap of vehicle surfaces of the vehicle (EGO) and the further vehicles (PE1 to PE3);
evaluating an execution of the lane change maneuver depending on a relative longitudinal position (Δx_{MM,init,PE}_{ᵢ}) of the vehicle (EGO) to the further vehicles (PE1 to PE3) and initial relative longitudinal speeds (Δv_{x,init,PE}_{ᵢ}) of the vehicle (EGO) to the further vehicles (PE1 to PE3) at a start of the lane change maneuver by a collision probability (P_{Collision}), as a safety measure (S1), and a minimum distance (d_{x,min}) in an event of no collision, as a further safety measure (S2);
wherein when determining the collision probability (P_{Collision}), a magnitude of a jerk (j) of a longitudinal acceleration (a_{x,PE}) of the further vehicles (PE1 to PE3) is taken into consideration; and
optimizing a longitudinal acceleration (a_{x,EGO}) of the vehicle (EGO) such that a minimum longitudinal acceleration (a_{x,PE},min) and a maximum longitudinal acceleration (a_{x,PE,max}) of the further vehicles (PE1 to PE3) require a longitudinal acceleration change effort which has a statistically low collision probability (P_{Collision});
wherein the collision probability (P_{Collision}), as the safety measure (S1), is determined by a previously determined probability of expected longitudinal accelerations (a_{x,PE}) of the further vehicles (PE1 to PE3), by a starting situation (Δx_{MM,init,PE}_{ᵢ}, Δv_{x,init,PE}_{ᵢ}), by geometric vehicle information of the vehicle (EGO) and geometric vehicle information of the further vehicles (PE1 to PE3), from start times of the hypothetical lane change maneuvers of the further vehicles (PE1 to PE3), a time duration of the lane change maneuver, and a planned longitudinal acceleration (a_{x,EGO,n}) of the vehicle (EGO).

5. The method according to claim 4, wherein the safety measure (S1) and the further safety measure (S2) are determined based on a model and wherein by changing the longitudinal acceleration (a_{x,EGO,n}) and/or the starting situation (Δx_{MM,init,PE}_{ᵢ}, Δv_{x,init,PE}_{ᵢ}) of the vehicle (EGO) to a next-moving further vehicle (PE1 to PE3), the collision probability (P_{Collision}) and the minimum distance (d_{x,min}) during the lane change maneuver are influenced.

6. The method according to claim 4, wherein an evaluation of the minimum distance (d_{x,min}) as the further safety measure (S2) is carried out via a minimum longitudinal distance between a bumper of the vehicle (EGO) and a bumper of the next-moving further vehicle (PE1 to PE3) and wherein the minimum distance (d_{x,min}) is chosen during the lane change maneuver after it is determined that respective transverse coordinates of the vehicle (EGO) and the further vehicles (PE1 to PE3) overlap.
